(19) United States
(12) Patent Application Publication
(10) Pub. No.: US 2021/0296754 A1
(43) Pub. Date: Sep. 23, 2021

(54) ADAPTIVE ANTENNA ASSEMBLY

(71) Applicant: Hewlett Packard Enterprise Development LP, Houston, TX (US)

(72) Inventors: Kuanyue LI, Beijing (CN); Yuying CHEN, Beijing (CN); Jianpo HAN, Beijing (CN)

(21) Appl. No.: 16/821,581

(22) Filed: Mar. 17, 2020

(51) Int. Cl. H01Q 1/12; H01Q 1/22; H01Q 21/06

(52) U.S. Cl. CPC H01Q 1/1221; H01Q 21/06; H01Q 1/2225

(57) ABSTRACT

Embodiments of the present disclosure relate to an antenna assembly, an apparatus including the antenna assembly, and a method. The antenna assembly comprises a first antenna element configured to communicate radio frequency (RF) signals with a first radiation pattern and a second antenna element configured to communicate RF signals with a second radiation pattern. A first vertical direction of the first radiation pattern is different from a second vertical direction of the second radiation pattern. The antenna assembly further includes a switch element configured to selectively connect the first or second antenna element to a RF circuit for processing of the RF signals to adapt to a mounting position of the antenna assembly. With such an antenna assembly assembling different antenna elements with different radiation patterns, the device can be flexibly mounted anywhere as needed, with low design and manufacturing costs and good signal coverage.

### BACKGROUND

Many communication devices are capable of wirelessly communicating with other devices. For example, devices may communicate with each other via wireless local area networks (WLANs) using corresponding communication technologies (such as Wi-Fi technologies). To this end, communication devices usually include antennas with associated radiation patterns. The antennas enable the devices to transmit and receive signals.

In a typical Wi-Fi based WLAN deployment, one or more access points (APs) are used to communicate wirelessly with each other and with other communication devices using Wi-Fi and provide access to another network (such as the Internet). APs may be mounted in different positions depending on the actual environment. Antennas need to be carefully designed in order to adapt to the mounting positions of the devices likes APs to provide good signal coverage.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIGS. 1A-1B illustrate schematic block diagrams illustrating example environments in which example embodiments of the present disclosure can be implemented:

FIG. 2 illustrates a block diagram of a device comprising an antenna assembly in accordance with some example embodiments of the present disclosure;

FIG. 3 illustrates an example of a omnidirectional radiation pattern and its elevation pattern and azimuth pattern;

FIGS. 4A-4B illustrate schematic block diagrams illustrating example environments in which the apparatus of the present disclosure can be installed therein;

FIG. 5 illustrates a block diagram of a device in accordance with some other example embodiments of the present disclosure;

FIG. 6 illustrates a block diagram of a device in accordance with some other example embodiments of the present disclosure:

FIGS. 7A-7B illustrate schematic block diagrams illustrating example environments in which the apparatus of the present disclosure can be installed therein; and

FIG. 8 illustrates a flowchart of a method in accordance with some example embodiments of the present disclosure.

### DETAILED DESCRIPTION

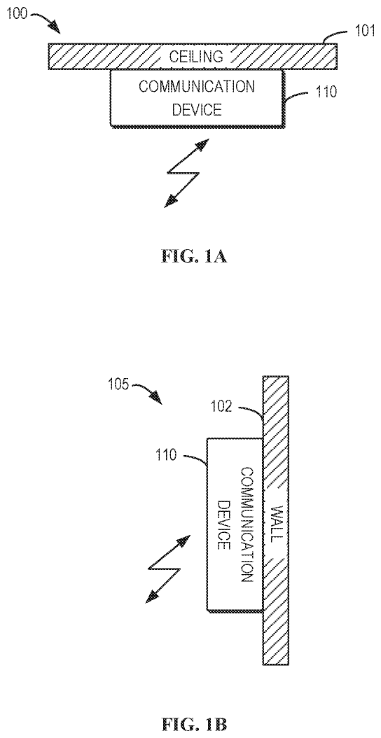

As described above, communication devices are mounted in different positions depending on the actual environments. FIGS. 1A-1B illustrate example environments where a communication device 110 can be installed therein.

In the environment 100 shown in FIG. 1A, the communication device 110 is mounted on a ceiling 101 of a room. In the environment 105 shown in FIG. 1B, the communication device 110 is mounted on a wall 102. The communication device 110 includes an antenna (not shown) which can wirelessly communicate (transmit and receive) radiation frequency (RF) signals with one or more other devices after the device is mounted in position.

The wireless communications of the communication device 110 may conform to any applicable communication protocols, such as the Institute of Electrical and Electronics Engineers (IEEE) 802.11-compatible communication protocols (which are sometimes collectively referred to as Wi-Fi communication protocols). Examples of the communication device 110 include, but are not limited to, an AP such as a Wi-Fi AP, a base station (BS) such as a micro BS and a pico BS, and/or any other communication devices with antennas to provide wireless communication. It is to be understood that although the ceiling mounting and wall mounting are illustrated, the communication device 110 may be mounted or placed in any other possible positions.

Antennas in communication devices such as APs need to be carefully designed in order to provide good signal coverage in different mounting positions. Traditionally different mounting positions require different antenna elements. e.g., specifically designed for ceiling mounting and wall mounting. As such, a device with the antenna element designed for one kind of mounting position cannot be installed in another kind of mounting position; otherwise, the signal coverage may be compromised. For example, a device with the antenna element designed for ceiling mounting cannot be mounted on a wall. It would take high efforts and costs for antenna design and manufacturing of the communication devices. On the other hand, customers have less flexibility and convenience as they always have to decide where a device is to be mounted before ordering the device.

Various example embodiments of the present disclosure propose an antenna assembly adaptive for different mounting positions. Specifically, the antenna assembly comprises at least two antenna elements. Each of the antenna elements is configured to communicate RF signals with a respective radiation pattern. Different radiation patterns have different vertical directions, so that the antenna elements can provide good signal coverage for different mounting positions (such as ceiling or wall), respectively.

Generally speaking, according to embodiments of the present disclosure, a switch element is comprised in the antenna assembly to selectively connect one of the antenna elements to a RF circuit, so that the radiation pattern of the selected antenna element matches the mounting position. In some example embodiments, a controller can determine the mounting position, e.g., based on a sensor(s) and/or user input and cause the switch element to selectively connect one of the antenna elements to the RF circuit based on the mounting position.

With such an antenna assembly assembling different antenna elements with different radiation patterns, the devices can be flexibly mounted anywhere as needed, with low design and manufacturing costs and good signal coverage. Other advantages of embodiments of the present disclosure will be described with reference to the example implementation below.

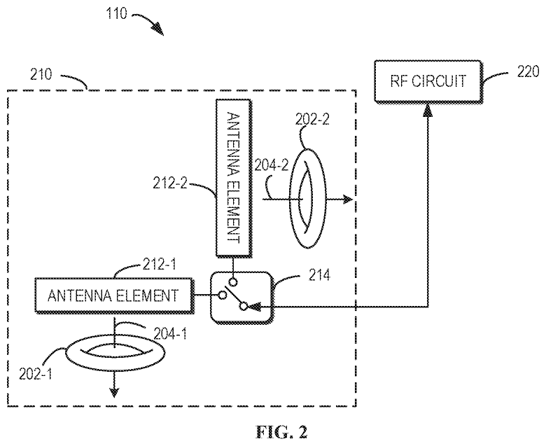

FIGS. 2-8 illustrate basic principles and several example embodiments of the present disclosure.

FIG. 2 illustrates a schematic block diagram illustrating a device comprising an antenna assembly in accordance with some example embodiments of the present disclosure. The device in FIG. 2 is illustrated as the communication device 110 in FIG. 1A and FIG. 1B.

As shown, the communication device 110 comprises an antenna assembly 210 that facilitates communication with one or more other devices. The antenna assembly 210 can be coupled with a RF circuit 220 of the communication device 110 which is configured for processing RF signals. The antenna assembly 210 is configured to communicate the RF signals with one or more other devices, for example, transmitting and/or receiving RF signals to and/or from the other device(s).

The RF circuit 220 is configured to process the RF signals to be communicated. In the case of signal transmission, the RF circuit 220 obtains signals from other circuits or components (not shown) of the communication device 110, generates RF signals, and provides the generated RF signals to the antenna assembly 210 for transmission. In the case of signal reception, the RF circuit 220 obtains RF signals received by the antenna assembly 210, processes the RF signals, and provides the resulting signals to other circuits or components (not shown) for further processing.

The antenna assembly 210 comprises a plurality of antenna elements 212-1, 212-2 (collectively or individually referred to as antenna elements 212) which are configured to generate respective radiation patterns 202-1, 202-2 (collectively or individually referred to as radiation patterns 202). Each of the antenna elements 212 can communicate the RF signals with the respective radiation patterns 202. It is to be understood that although two antenna elements are illustrated, more antenna elements can be comprised in the antenna element assembly 210 in other examples.

The antenna elements 212 may be transmit antenna elements which only transmit RF signals from the RF circuit 220 or receive antenna elements which only receive RF signals for the RF circuit 220. In some examples, the antenna elements 212 may be transmit and receive antenna elements which can communicate RF signals in both directions. In some embodiments, the antenna elements 212 may be built into the communication device 110.

The antenna elements 212 may comprise any types of antennas that can communicate the RF signals using beamforming and polarization technologies with any suitable antenna gains. In some example embodiments, one or more of the antenna elements 212 may be configured to generate an omnidirectional radiation pattern, which can provide wider signal coverage in each mounting position. An antenna element generating an omnidirectional radiation pattern may be referred to as an omnidirectional antenna element.

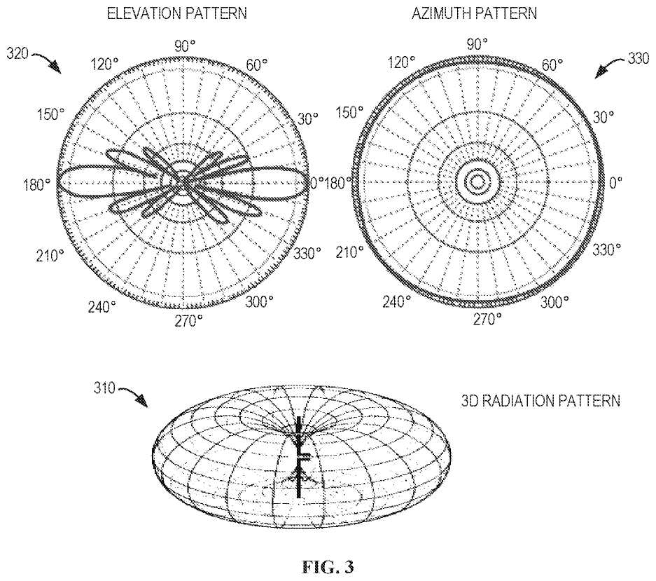

FIG. 3 illustrates an example of a three-dimensional (3D) omnidirectional radiation pattern 310 of an antenna element. FIG. 3 further illustrates an elevation pattern 320 of the omnidirectional radiation pattern 310 and an azimuth pattern 330 of the omnidirectional radiation pattern 310. It is noted that the example shown in FIG. 3 is merely provided for purpose of illustration and other omnidirectional radiation patterns are also applicable for the antenna elements 212.

In example embodiments of the present disclosure, the antenna assembly 210 is adaptive to different mounting positions of the communication device 110 with the different antenna elements 212. Different antenna elements 212 in the antenna assembly 210 are adapted to different mounting positions, respectively. In particular, the antenna elements 212 are configured and arranged in such a way that the radiation patterns 202 of the antenna elements 212 have different vertical directions, such as a vertical direction 204-1 for the radiation pattern 202-1 and a vertical direction 204-2 for the radiation pattern 202-2. The vertical directions 204-1 and 204-2 are sometimes collectively or individually referred to as vertical directions 204. A vertical direction of a radiation pattern refers to a direction vertical to a transmit/receive plane of the antenna element.

The vertical directions 204 of the radiation patterns 202 of the antenna elements 212 are different in that the vertical directions 204 are deviated from each other at certain angles. In different mounting positions, the communication device 110 may be placed in different ways and the signal coverage space of one antenna element 212 changes accordingly. The different vertical directions 204 of the radiation patterns 202 can ensure that at least one of the antenna elements 212 can provide signal coverage when the communication device 110 is placed in a certain position.

In some example embodiments, a radiation pattern 202 of one antenna element 212 may be configured to be adapted to signal coverage from a ceiling, and a radiation pattern 202 of another antenna element 212 may be configured to be adapted to signal coverage from a wall. Additionally, or as an alternative, one or more antenna elements 212 in the antenna assembly 210 may be configured with antenna patterns adapt to signal coverage from other possible mounting positions.

In some example embodiments, vertical directions 204 of the radiation patterns 202 of different antenna elements 212 may be perpendicular to one another. For example, the vertical direction 204-1 of the radiation pattern 202-1 of the antenna element 212-1 may be perpendicular to the vertical direction 204-2 of the radiation pattern 202-2 of the antenna element 212-2. This arrangement is particularly beneficial to signal coverage for the ceiling mounting position and the wall mounting position.

In some example embodiments, the antenna elements 212 may be arranged to be spatially separated from each other. As such, it is easier to configure the respective antenna elements 212 to be adapted to different mounting positions with good signal coverage.

In order to adapt to a mounting position of the communication device 110, the antenna assembly 210 further comprises a switch element 214 which is configured to selectively connect one of the antenna elements 212 to the RF circuit 220. The switch element 214 at least comprises a first terminal connected to the RF circuit 220 and a plurality of second terminals connected to the antenna elements 212, respectively. A connection can be established between the first terminal and one of the second terminals in order to connect the RF circuit 220 with one of the antenna elements 212.

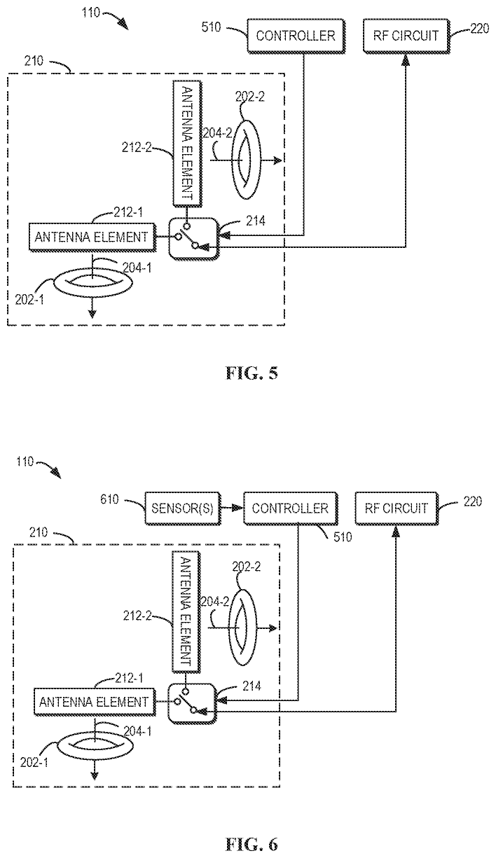

The switch element 214 may be controlled manually or automatically. In the embodiments of manual control, the switch element 214 may be manually operated or otherwise receive a user input to connect the RF circuit 220 to one of the antenna elements 212. Some visual indications may be presented on the housing of the communication device 110 to guide the user to select the correct antenna element 212. In some examples, the manual connection of the RF circuit 220 and the antenna element 212 may be performed before or after the communication device 110 is actually installed. In the embodiments of automatic control, the selective connection between the RF circuit 220 and an antenna element 212 may be controlled via a control signal from a controller, which will be discussed in detail below with reference to FIG. 5.

In deployment, once the mounting position of the communication device 110 is determined, one of the antenna elements 212 which is adapted to the determined mounting position can be connected to the RF circuit 220 through the switch element 214, while the other antenna element(s) 212 will not be used. The connected antenna element 212 is then used for communication with the corresponding radiation pattern 202.

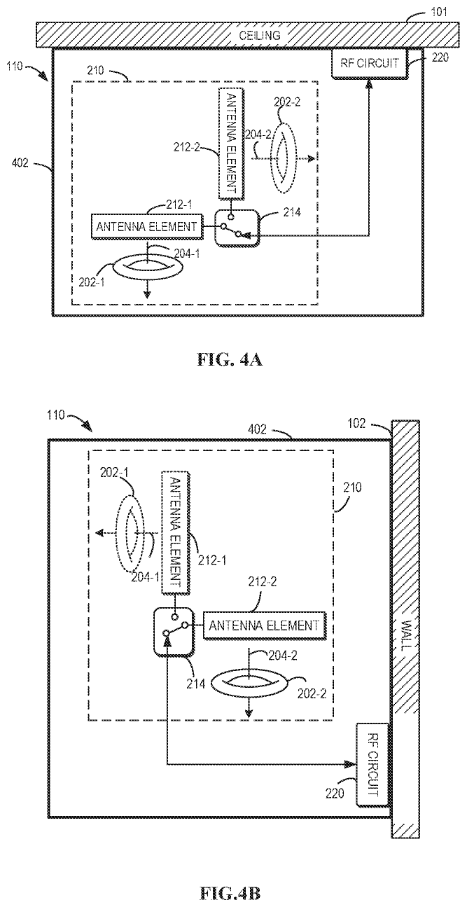

As an example, if the communication device 110 is mounted on the ceiling 101 through a housing 402 of the communication device 110 as illustrated in FIG. 4A (similar to the environment 100 of FIG. 1A), the antenna element 212-1 adapted to the ceiling mounting position is connected to the RF circuit 220 through the switch element 214 and the antenna element 212-2 remains unused.

As another example, the communication device 110 can be hang on a wall 102 through the housing 402 as illustrated in FIG. 4B (similar to the environment 105 of FIG. 1B). In this situation, the antenna element 212-2 adapted to the wall mounting position is connected to the RF circuit 220 through the switch element 214 and the antenna element 212-1 will not be used.

By means of the antenna assembly 210, it is possible to avoid dedicated antenna designs and manufacturing of devices for various mounting positions, which thus can reduce the design and manufacturing costs. A single communication device equipped with the antenna assembly 210 can be flexibly mounted anywhere as needed.

As mentioned above, the switch element 214 may be controlled by a controller in an automatic manner. FIG. 5 illustrates an example of the communication device 110 in some example embodiments where the communication device 110 comprises a controller 510 to control the switch element 214 automatically. In such embodiments, the controller 510 is configured to control the switch element 214 to select one of the antenna elements 212 to the RF circuit 220, so that the radiation pattern 202 of the selected antenna element 212 is adapted to a mounting position of the communication device 110.

The controller 510 may determine the mounting position of the communication device 110 in a variety of ways. In some example embodiments, the mounting position may be detected by one or more sensor(s) and informed to the controller 510. FIG. 6 illustrates a further example of the communication device 110 in some example embodiments where the communication device 110 further comprises one or more sensors 610 to detect information indicative of the mounting position of the communication device 110.

The sensor(s) 610 may comprise any type of sensors that can be used to detect or facilitate detection of the mounting position. In some example embodiments, the sensor(s) 610 may comprise one or more sensors that are used to detect gravity related information to determine the mounting position because no matter where the communication device 110 is mounted, the gravity direction is always fixed. Examples of the sensor(s) 610 include, but are not limited to, one or more gyroscopes, one or more accelerometers, one or more gravity sensors, one or more magnetometers, and/or the like. The detection technologies of those sensors are well known and are not described herein.

The detected information may be provided by the sensor(s) 610 to the controller 510 to determine the mounting position of the communication device 110. In some example embodiments, the controller 510 may determine, from the detected information, an offset of a mounting plane on which the communication device 110 is mounted from a gravity direction. The offset can indicate where the communication device is mounted.

Generally, the communication device 110 has a specific mounting plane. The communication device 110 will be mounted on the mounting plane. The mounting plane may, for example, be corresponding to one side of the housing of the communication device 110 (such as the housing 402). If the communication device 110 is mounted in a specific mounting position (the ceiling or the wall), the mounting plane is generally in parallel with the surface where the communication device 110 is mounted. Thus, the offset of the mounting plane from the gravity direction changes as the mounting positions of the communication device 110 changes. Accordingly, the controller 510 can determine the mounting position of the communication device 110 based on the offset.

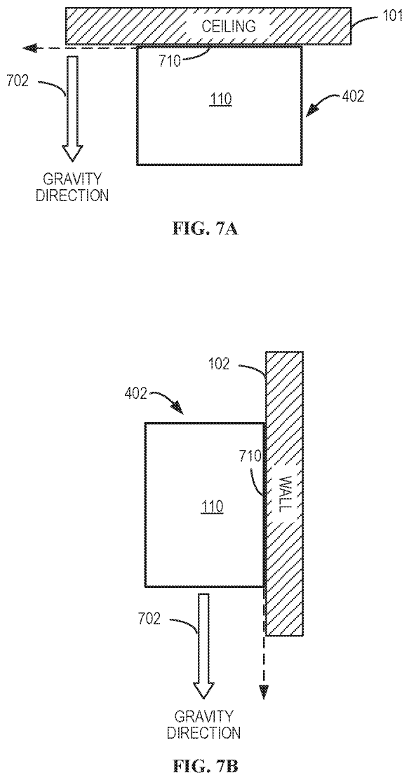

Some examples of the determination of the ceiling mounting position and the wall mounting position based on the offset will be described with reference to FIGS. 7A and 7B. For purpose of brevity, the components or circuits in the communication device 110 are omitted in FIGS. 7A and 7B.

In the example of FIG. 7A, the communication device 110 is mounted to the ceiling 101 as in the environment 100 of FIG. 1A on a mounting plane 710 of the housing 402. In this example, the sensor(s) 610, such as the gyroscope, may detect that the mounting plane 710 is offset from the gravity direction 702 with an approximately 90 degree of angle, which indicates that the mounting plane 710 is perpendicular to the gravity direction 702. Accordingly, the controller 510 may determine, based on the offset, that the communication device 110 is mounted on a ceiling.

In the example of FIG. 7B, the communication device 110 is mounted to the wall 102 as in the environment 105 of FIG. 1B on the same mounting plane 710 as in the example of FIG. 7A. In this example, the sensor(s) 610, such as the gyroscope, may detect that the mounting plane 710 is offset from the gravity direction 702 with an approximately zero degree of angle, which indicates that the mounting plane 710 is in parallel with the gravity direction. The controller 510 may determine, based on the offset, that the communication device 110 is mounted on a wall.

With the mounting position determined, the controller 510 selects one of the antenna elements 212 that is adapted to the determined mounting position to connect to the RF circuit 220 and causes the selected antenna element 212 to connect to the RF circuit 220. For example, if the communication device 110 is determined to be mounted on a ceiling, the controller 510 may select the antenna element 212 with its antenna pattern 202 adapted to signal coverage from the ceiling to connect to the RF circuit 220. As another example, if the mounting position is on the wall, the controller 510 may select the antenna element 212 with its antenna pattern 202 adapted to signal coverage from the wall to connect to the RF circuit 220.

In some example embodiments, the antenna patterns 202 of the antenna elements 212 may be configured with respect to the mounting plane of the communication device 110 in order to facilitate the selection of the antenna elements 212 when the communication device 110 is mounted. For example, the antenna pattern 202-1 of the antenna element 212-1 may be configured with its vertical direction 204-1 perpendicular to the mounting plane of the communication device 110 while the antenna pattern 202-2 of the antenna element 212-2 may be configured with its vertical direction 204-2 in parallel with the mounting plane. Thus, the antenna element 212-1 may be selected in the case of ceiling mounting position and the antenna element 212-2 may be selected in the case of wall mounting position.

The controller 510 may send a control signal to the switch element 214 to trigger the connection between the RF circuit 220 and the selected antenna element 212. In some examples, before sending the control signal, the controller 510 may determine and confirm that the communication device 110 has been mounted in position.

Some example embodiments related to the ceiling mounting and wall mounting are described above. It would be appreciated that the communication device 110 may be equipped with one or more antenna elements having radiation patterns adapted to other mounting positions, such as some positions with sloping surfaces. The controller 510 can also determine the mounting position using sensing information (such as gravity related information) detected by the sensor(s) 610 and select the suitable antenna element for the corresponding mounting position.

Some examples of the communication device 110 have been illustrated and discussed above. The antenna elements 212, the switch element 214, the RF circuit 220, and/or the controller 510 may be implemented as an apparatus included in the communication device 110. Although not illustrated, one or more other circuits or components may be included in the communication device 110 to implement communication, processing, and other functionalities. In some example embodiments, the switch element 214, the RF circuit 220, and/or the controller 510 may be implemented in a same printed circuit board (PCB) or different PCBs. The scope of the present disclosure is not limited in this regard.

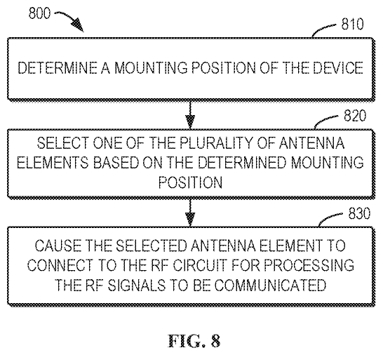

FIG. 8 illustrates a flowchart of a method 800 in accordance with some example embodiments of the present disclosure. The method 800 can be carried out by the communication device 110 (especially the controller 510 comprised therein) according to the embodiments described herein, and the features described above with respect to the communication device 110 can apply to the method 800. While only three blocks are shown in the method 800, the method 800 may comprise other operations described herein.

At block 810, the communication device 110 determines a mounting position of the communication device 110.

At block 820, the communication device 110 selects one of the plurality of antenna elements 212 based on the determined mounting position.

At block 830, the communication device 110 causes the selected antenna element 212 to connect to the RF circuit 220 for processing the RF signals to be communicated.

In some example embodiments, to determine the mounting position, the communication device 110 may obtain, from at least one sensor 610, information indicative of the mounting position and determine the mounting position based on the obtained information.

In some example embodiments, to determine the mounting position based on the obtained information, the communication device 110 may determine, from the obtained information, an offset of a mounting plane on which the communication device 110 is mounted from a gravity direction. If the offset indicates that the mounting plane is perpendicular to the gravity direction, the communication device 110 may determine that the mounting position is a ceiling. If the offset indicates that the mounting plane is in parallel with the gravity direction, the communication device 110 may determine the mounting position is a wall.

In some example embodiments, if it is determined that the communication device 110 is mounted on a ceiling, the communication device 110 may select a first antenna element 212 from the plurality of antenna elements 212, a first radiation pattern of the first antenna element 212 adapted to signal coverage from the ceiling. If it is determined that the communication device 110 is mounted on a wall, the communication device 110 may select a second antenna element 212 from the plurality of antenna elements 212, a second radiation pattern of the first antenna element adapted to signal coverage from the wall. In some example embodiments, a first vertical direction of the first radiation pattern is perpendicular to a second vertical direction of the second radiation pattern.

In some example embodiments, after determining that the communication device 110 has been mounted in position, the communication device 110 may cause the switch element 214 to select one of the plurality of antenna elements 212 to the RF circuit 220.

While the preceding discussion used a Wi-Fi communication protocol as an illustrative example, in other embodiments a wide variety of communication protocols and, more generally, wireless communication techniques may be used. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

The present disclosure also provides at least one computer program product tangibly stored on a non-transitory computer-readable storage medium. The computer program product includes program codes or instructions which can be executed to carry out the method as described above with reference to FIG. 8.

Program codes or instructions for carrying out methods of the present disclosure may be written in any combination of one or more programming languages. These program codes or instructions may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine or entirely on the remote machine or server.

In the context of this disclosure, a computer-readable medium may be any tangible medium that may contain, or store a program for use by or in connection with an instruction execution system, apparatus, or device. The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Certain features that are described in the context of separate embodiments may also be implemented in combination in a single implementation. Conversely, various features that are described in the context of a single implementation may also be implemented in multiple embodiments separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

1. An antenna assembly comprising:
a first antenna element configured to communicate radio frequency (RF) signals with a first radiation pattern;
a second antenna element configured to communicate RF signals with a second radiation pattern, a first vertical direction of the first radiation pattern being different from a second vertical direction of the second radiation pattern, wherein the first vertical direction of the first radiation pattern is perpendicular to the second vertical direction of the second radiation pattern, and wherein at least one of the first or second radiation pattern is an omnidirectional radiation pattern; and
a switch element configured to selectively connect the first or second antenna element to a RF circuit for processing of the RF signals to adapt to a mounting position of the antenna assembly, wherein the switch element is configured to:
connect the first antenna element to the RF circuit in accordance with a determination that the mounting position is a ceiling; and
connect the second antenna element to the RF circuit in accordance with a determination that the mounting position is a wall.

2. (canceled)

3. (canceled)

4. The antenna assembly of claim 1, wherein the first antenna element is spatially separated from the second antenna element.

5. The antenna assembly of claim 1, wherein the switch element is configured to selectively connect the first or second antenna element to the RF circuit based on a control signal generated by a controller of an apparatus comprising the antenna assembly.

6. (canceled)

7. An apparatus comprising:
an antenna assembly comprising a plurality of antenna elements and a switch element, the plurality of antenna elements configured to communicate radio frequency (RF) signals with respective radiation patterns, and vertical directions of the respective radiation patterns being different from one another;
a RF circuit configured to process the RF signals to be communicated; and
a controller configured to cause the switch element to select one of the plurality of antenna elements to the RF circuit, so that the radiation pattern of the selected antenna element is adapted to a mounting position of the apparatus, wherein the controller is configured to:
in accordance with a determination that the apparatus is mounted on a ceiling, cause the switch element to connect a first antenna element from the plurality of antenna elements to the RF circuit, a first radiation pattern of the first antenna element adapted to signal coverage from the ceiling; and
in accordance with a determination that the apparatus is mounted on a wall, cause the switch element to connect a second antenna element from the plurality of antenna elements to the RF circuit, a second radiation pattern of the second antenna element adapted to signal coverage from the wall, wherein a first vertical direction of the first radiation pattern is perpendicular to a second vertical direction of the second radiation pattern, and wherein at least one of the respective radiation patterns is an omnidirectional radiation pattern.

8. The apparatus of claim 7, further comprising:
at least one sensor configured to detect information indicative of the mounting position of the apparatus, and
wherein the controller is further configured to receive the sensing information from the at least one sensor and determine the mounting position of the apparatus based on the detected information.

9. The apparatus of claim 8, wherein the controller is configured to:
determine, from the detected information, an offset of a mounting plane on which the apparatus is mounted from a gravity direction; and
determine the mounting position of the apparatus based on the offset.

10. The apparatus of claim 9, wherein the controller is configured to:
in accordance with a determination from the offset that the mounting plane is perpendicular to the gravity direction, determine that the mounting position of the apparatus is a ceiling; and
in accordance with a determination from the offset that the mounting plane is in parallel with the gravity direction, determine that the mounting position of the apparatus is a wall.

11. The apparatus of claim 9, wherein the at least one sensor comprises at least one of a gyroscope or an accelerometer.

12. (canceled)

13. (canceled)

14. (canceled)

15. The apparatus of claim 8, wherein the apparatus is at least a part of an access point (AP).

16. A method comprising:
determining a mounting position of an apparatus comprising an antenna assembly and a radio frequency (RF) circuit, the antenna assembly comprising a plurality of antenna elements configured to communicate RF signals with respective radiation patterns, vertical directions of the respective radiation patterns being different from one another;
selecting one of the plurality of antenna elements based on the determined mounting position of the apparatus by:
in accordance with a determination that the apparatus is mounted on a ceiling, selecting a first antenna element from the plurality of antenna elements, a first radiation pattern of the first antenna element adapted to signal coverage from the ceiling; and
in accordance with a determination that the apparatus is mounted on a wall, selecting a second antenna element from the plurality of antenna elements, a second radiation pattern of the second antenna element adapted to signal coverage from the wall, wherein a first vertical direction of the first radiation pattern is perpendicular to a second vertical direction of the second radiation pattern, and wherein at least one of the respective radiation patterns is an omnidirectional radiation pattern;
causing the selected antenna element to connect to the RF circuit for processing the RF signals to be communicated.

17. The method of claim 16, wherein determining the mounting position of the apparatus comprises:
obtaining, from at least one sensor of the apparatus, information indicative of the mounting position of the apparatus; and
determining the mounting position of the apparatus based on the obtained information.

18. The method of claim 17, wherein determining the mounting position of the apparatus based on the obtained information comprises:
determining, from the obtained information, an offset of a mounting plane on which the apparatus is mounted from a gravity direction;
in accordance with a determination from the offset that the mounting plane is perpendicular to the gravity direction, determining that the mounting position of the apparatus is a ceiling; and
in accordance with a determination from the offset that the mounting plane is in parallel with the gravity direction, determining that the mounting position of the apparatus is a wall.

19. (canceled)

20. (canceled)
